(19) United States
(12) Patent Application Publication
(10) Pub. No.: US 2010/0041296 A1
(43) Pub. Date: Feb. 18, 2010

(54) ELECTROBLOWING OF FIBERS FROM MOLECULARLY SELF-ASSEMBLING MATERIALS

(76) Inventors: Leonardo C. Lopez, Midland, MI (US); Daniel A. Alderman, Midland, MI (US)

Correspondence Address: The Dow Chemical Company, Intellectual Property Section, P.O. Box 1967, Midland, MI, 48641-1967, US

(21) Appl. No.: 12/539,796

(22) Filed: Aug. 12, 2009

Related U.S. Application Data
(60) Provisional application No. 61/088,545, filed on Aug. 13, 2008.

(51) Int. Cl. D04H 3/02; B29C 47/00

(52) U.S. Cl. 442/351; 264/465; 428/364

(57) ABSTRACT

This disclosure relates to a process for fabricating fibers and nonwoven webs, preferably sub-micron fibers and nonwoven webs, comprising electroblowing a fluid comprising a self-assembling material, and articles made therefrom.

### CROSS-REFERENCE TO RELATED APPLICATION(S)

This application claims benefit of priority from U.S. Provisional Patent Application No. 61/088,545, filed Aug. 13, 2008, which application is incorporated by reference herein in its entirety.

### FIELD

This invention relates to a process for fabricating electroblown sub-micron diameter fibers and nonwoven webs from molecularly self-assembling materials.

### BACKGROUND

Producing submicron diameter fibers (fibers smaller than about 1.0 micron in diameter) and nonwoven webs at commercially acceptable rates, is technologically difficult both in terms of materials and processing techniques. For example, solvent electro-spinning with known polymers produces fibers on the order of about 0.1 to 1.5-2.0 microns at low throughputs, and also requires solvent removal and recovery. Melt electrospinning, in theory, has some potential to produce sub-micron fibers but also has constraints and limitations, including requiring very low viscosity polymers to increase production rates which leads to poor ultimate fiber properties. Melt blowing, at useful production rates, has similar deficiencies to melt electrospinning but fiber sizes are usually even larger. A technique called “electroblowing” (EB) has been proposed for producing submicron-fibers. This process attempts to combine aspects of electrospinning and melt blowing technology to further improve production capability of sub-micron fibers and webs. But, electroblowing has apparently only been demonstrated for polymer solutions as material constraints also appear to limit the utility of this technique. Accordingly, there is an ongoing need in the art for producing small fibers for materials that can be used to produce sub-micron fibers from melts and for high concentration solutions at useful production rates.

### BRIEF SUMMARY OF THE INVENTION

In a first aspect, there is disclosed, a process for fabricating fibers, the process comprising electroblowing a fluid comprising a molecularly self-assembling material, thereby producing fibers comprising the molecularly self-assembling material. The process is run at a temperature of about room temperature (i.e., 20° C.) to 300° C. producing a fiber set having a distribution of fiber diameters wherein at least about 95% of the fibers have a diameter of less than about 3 microns.

The process is useful in both fluids that are melts and solution-based fluids and can be used to produce both sub-micron fibers and nonwoven webs. Additional features and advantages of preferred embodiments of the invention will be described hereinafter. It should be appreciated that the specific embodiments are to be treated as preferred embodiments and not necessarily to be considered limitations of the broadest conception of the invention.

### BRIEF DESCRIPTION OF THE FIGURES

FIG. 1 is an exemplary representation of the basic electroblowing process.

FIGS. 2a and 2b are exemplary electroblowing die/capillary/spinneret-tips illustrating basic geometries.

It is to be expressly understood, however, that each of the figures is provided for the purpose of illustration and description only and is not intended as a definition of the limits of the present invention.

### DETAILED DESCRIPTION

The invention comprises electroblowing a fluid (defined below) comprising a molecularly self-assembled materials (MSA—defined below, also interchangeably referred to herein as self-assembling materials or molecularly self-assembling oligomers or polymers) into fibers, the fibers having a high percentage of small diameter fibers, preferably micron-sized fibers, or smaller, and having a narrow average size distribution of these fiber diameters. The fluid temperatures are from about room temperature (e.g. about 20° C.) to 300° C. The fibers are collected into a fiber set so as to form a fibrous web.

The fiber set produced has a distribution of fiber diameters wherein at least about 95% of the fibers have a diameter of less than 3 microns, preferably less than 2.0 microns, more preferably less than 1.5 microns, and even more preferably less than 0.75 microns. The fiber set can have a distribution of fiber diameters wherein about 75% of the fibers are between about 0.25 and 0.65 micron in diameter and more preferably wherein about 50% of the fibers are between 0.25 and 0.5 microns in diameter.

All liquids and all gases are fluids. Fluids include liquids, gases, solutions, and polymeric materials above their melt or glass transition temperature. The fluids that can be electroblown are melts of molecularly self-assembling materials and solutions of self-assembling materials.

### Molecularly Self-Assembling Materials

The term “molecularly self-assembling material” or “molecularly self-assembled material” or “MSA” means an oligomer or polymer that effectively forms larger associated or assembled oligomers and/or polymers through the physical intermolecular associations of chemical functional groups. Without wishing to be bound by theory, it is believed that the intermolecular associations do not increase the molecular weight (Mn-Number Average molecular weight) or chain length of the self-assembling material and covalent bonds between said materials do not form. This combining or assembling occurs spontaneously upon a triggering event such as cooling to form the larger associated or assembled oligomer or polymer structures. Examples of other triggering events are the shear-induced crystallizing of, and contacting a nucleating agent to, a self-assembling material. Accordingly, MSAs can exhibit mechanical properties similar to some higher molecular weight synthetic polymers and viscosities like very low molecular weight compounds. MSA organization (self-assembly) is caused by non-covalent bonding interactions, often directional, between molecular functional groups or moieties located on individual molecular (i.e. oligomer or polymer) repeat units (e.g. hydrogen-bonded arrays). Non-covalent bonding interactions include: electrostatic interactions (ion-ion, ion-dipole or dipole-dipole), coordinative metal-ligand bonding, hydrogen bonding, π-π-structure stacking interactions, donor-acceptor, and/or van der Waals forces and can occur intra- and intermolecularly to impart structural order. One preferred mode of self-assembly is hydrogen-bonding and this non-covalent bonding interactions can be defined by a mathematical “Association constant”, K(assoc) constant describing the relative energetic interaction strength of a chemical complex or group of complexes having multiple hydrogen bonds. Such complexes give rise to the higher-ordered structures in a mass of MSA materials. A description of self assembling multiple H-bonding arrays can be found in “Supramolecular Polymers”, Alberto Ciferri Ed., 2nd Edition, pages (pp) 157-158. A “hydrogen bonding array” is a purposely synthesized set (or group) of chemical moieties (e.g. carbonyl, amine, amide, hydroxyl. etc.) covalently bonded on repeating structures or units to prepare a self assembling molecule so that the individual functional moieties can form self assembling donor-acceptor pairs with other donors and acceptors on the same, or different, molecule. A “hydrogen bonded complex” is a chemical complex formed between hydrogen bonding arrays. Hydrogen bonded arrays can have association constants K (assoc) between 10² and 10⁹ M⁻¹ (reciprocal molarities), generally greater than 10³ M⁻¹. The arrays can be chemically the same or different and form complexes.

Accordingly, the molecularly self-assembling materials (MSA) suitable for melt-blowing presently include: self assembling polyesteramides, copolyesteramide, copolyetheramide, copolyetherester-amide, copolyetherester-urethane, copolyether-urethane, copolyester-urethane, copolyester-urea, copolyetherester-urea and their mixtures. Preferred MSA include copolyesteramide, copolyether-amide, copolyester-urethane, and copolyether-urethanes. The MSA preferably has number average molecular weights, MWₙ (as is preferably determined by NMR spectroscopy) of 2000 grams per mole or more, more preferably at least about 3000 g/mol, and even more preferably at least about 5000 g/mol. The MSA preferably has MWₙ 50,000 g/mol or less, more preferably about 20,000 g/mol or less, yet more preferably about 15,000 g/mol or less, and even more preferably about 12,000 g/mol or less. The MSA material can comprise self assembling repeat units, preferably comprising (multiple) hydrogen bonding arrays, wherein the arrays have an association constant K (assoc) preferably from 10² to 10⁹ reciprocal molarity (M⁻¹) more preferably greater than 10³ M⁻¹: association of multiple-hydrogen-bonding arrays comprising donor-acceptor hydrogen bonding moieties is the preferred mode of self assembly. The multiple H-bonding arrays preferably comprise an average of 2 to 8, more preferably 4-6, and still more preferably at least 4 donor-acceptor hydrogen bonding moieties per self assembling unit. Self assembling units in the MSA can include bis-amide groups, and bis-urethane group repeat units and their higher oligomers.

The MSA materials can include “non-aromatic hydrocarbylene groups” and this term means specifically herein hydrocarbylene groups (a divalent radical formed by removing two hydrogen atoms from a hydrocarbon) not having or including any aromatic structures such as aromatic rings (e.g. phenyl) in the backbone of the oligomer or polymer repeating units. These groups can optionally be substituted with various substituents, or functional groups, including but not limited to: halides, alkoxy groups, hydroxy groups, thiol groups, ester groups, ketone groups, carboxylic acid groups, amines, and amides. A “non-aromatic heterohydrocarbylene” is a hydrocarbylene that includes at least one non-carbon atom (e.g. N, O, S, P or other heteroatom) in the backbone of the polymer or oligomer chain, and that does not have or include aromatic structures the backbone of the polymer or oligomer chain. These groups can optionally be substituted with various substituents, or functional groups, including but not limited to: halides, alkoxy groups, hydroxy groups, thiol groups, ester groups, ketone groups, carboxylic acid groups, amines, and amides. Heteroalkylene is an alkylene group having at least one non-carbon atom (e.g. N, O, S or other heteroatom) that can optionally be substituted with various substituents, or functional groups, including but not limited to: halides, alkoxy groups, hydroxy groups, thiol groups, ester groups, ketone groups, carboxylic acid groups, amines, and amides. For the purpose of this disclosure, a “cycloalkyl” group is a saturated carbocyclic radical having three to twelve carbon atoms, preferably three to seven. A “cycloalkylene” group is an unsaturated carbocyclic radical having three to twelve carbon atoms, preferably three to seven. The cycloalkylene can be monocyclic, or a polycyclic fused system as long as no aromatics are included. Cycloalkyl and cycloalkylene groups can be monocyclic, or a polycyclic fused system as long as no aromatics are included. Examples of such carbocyclic radicals include cyclopropyl, cyclobutyl, cyclopentyl, cyclohexyl and cycloheptyl. The groups herein can be optionally substituted in one or more substitutable positions as would be known in the art. For example, cycloalkyl and cycloalkylene groups can be optionally substituted with, among others, halides, alkoxy groups, hydroxy groups, thiol groups, ester groups, ketone groups, carboxylic acid groups, amines, and amides. Cycloalkyl and cycloalkene groups can optionally be incorporated into combinations with other groups to form additional substituent groups, for example: “-Alkylene-cycloalkylene-, “-alkylene-cycloalkylene-alkylene-”, “-heteroalkylene-cycloalkylene-”, and “-heteroalkylene-cycloalkyl-heteroalkylene” which refer to various non-limiting combinations of alkyl, heteroalkyl, and cycloalkyl. These can include groups such as oxydialkylenes (e.g., diethylene glycol), groups derived from branched diols such as neopentyl glycol or derived from cyclo-hydrocarbylene diols such as Dow Chemical's UNOXOL® isomer mixture of 1,3- and 1,4-cyclohexanedimethanol, and other non-limiting groups, such -methylcylohexyl-, -methyl-cyclohexyl-methyl-, and the like. The cycloalkyl can be monocyclic, or a polycyclic fused system as long as no aromatics are included. “Heterocycloalkyl” is one or more carbocyclic ring systems having 4 to 12 atoms and containing at least one and up to four heteroatoms selected from nitrogen, oxygen, or sulfur. This includes fused ring structures. Preferred heterocyclic groups contain two ring nitrogen atoms, such as piperazinyl. The heterocycloalkyl groups herein can be optionally substituted in one or more substitutable positions. For example, heterocycloalkyl groups may be optionally substituted with halides, alkoxy groups, hydroxy groups, thiol groups, ester groups, ketone groups, carboxylic acid groups, amines, and amides.

A preferred class of self-assembling materials useful in the presently invention are polyester-amide and polyester-urethane polymers (optionally containing polyether units) such as those described in U.S. Pat. No. 6,172,167, PCT application number PCT/US2006/023450 and publication number WO2007/030791, each of which is expressly incorporated herein by reference.

In a set of preferred embodiments, the self-assembling material comprises ester repeat units of Formula I:

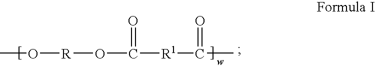

and at least one second repeat unit selected from the esteramide units of Formula II and III:

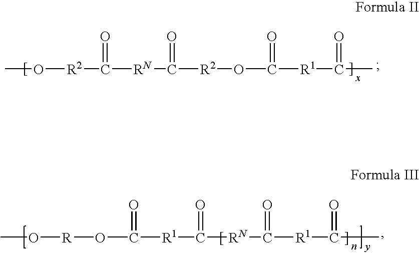

and the ester-urethane units of Formula IV:

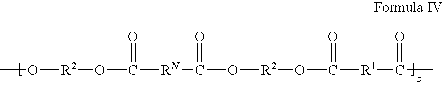

R is at each occurrence, independently a C₂-C₂₀ non-aromatic hydrocarbylene group, a C₂-C₂₀ non-aromatic heterohydrocarbylene group, or a polyalkylene oxide group having a group molecular weight of from about 100 to about 5000 g/mol. In preferred embodiments, the C₂-C₂₀ non-aromatic hydrocarbylene at each occurrence is independently specific groups: alkylene-, -cycloalkylene-, -alkylene-cycloalkylene-, -alkylene-cycloalkylene-alkylene-(including dimethylene cyclohexyl groups). Preferably, these aforementioned specific groups are from 2 to 12 carbon atoms, more preferably from 3 to 7 carbon atoms. The C₂-C₂₀ non-aromatic heterohydrocarbylene groups are at each occurrence, independently specifically groups, non-limiting examples including: -hetereoalkylene-, -heteroalkylene-cycloalkylene-, -cycloalkylene-heteroalkylene-, or -heteroalkylene-cycloalkylene-heteroalkylene-, each aforementioned specific group preferably comprising from 2 to 12 carbon atoms, more preferably from 3 to 7 carbon atoms. Preferred heteroalkylene groups include oxydialkylenes, for example diethylene glycol (—CH₂CH₂OCH₂CH₂—O—). When R is a polyalkylene oxide group it can preferably be a polytetramethylene ether, polypropylene oxide, polyethylene oxide, or their combinations in random or block configuration wherein the molecular weight (Mn-average molecular weight, or conventional molecular weight) is preferably about 250 g/ml to 5000, g/mol, more preferably more than 280 g/mol, and still more preferably more than 500 g/mol, and is preferably less than 3000 g/ml: mixed length alkylene oxides can be also be included. Other preferred embodiments include species where R is the same C₂-C₆ alkylene group at each occurrence, and most preferably it is —(CH₂)₄—.

R¹ is at each occurrence, independently, a bond, or a C₁-C₂₀ non-aromatic hydrocarbylene group. In some preferred embodiments, R¹ is the same C₁-C₆ alkylene group at each occurrence, most preferably —(CH₂)₄—.

R² is at each occurrence, independently, a C₁-C₂₀ non-aromatic hydrocarbylene group. According to another embodiment, R² is the same at each occurrence, preferably C₁-C₆ alkylene, and even more preferably R² is —(CH₂)₂—, —(CH₂)₃—, —(CH₂)₄—, or —(CH₂)₅—.

R^{N} is at each occurrence can be —N(R³)—Ra—N(R³)—, where R³ is independently H or can be a C₁-C₆ alkyl, preferably C₁-C₄ alkyl, or R^{N} is a C₂-C₂₀ heterocycloalkylene group containing the two nitrogen atoms, wherein each nitrogen atom is bonded to a carbonyl group according to Formula II or III above; w represents the ester mol fraction, and x, y and z represent the amide or urethane mole fractions where w+x+y+z=1, 0<w<1, and at least one of x, y and z is greater than zero. Ra is a C₂-C₂₀ non-aromatic hydrocarbylene group, more preferably a C₂-C₁₂ alkylene: most preferred Ra groups are ethylene butylene, and hexylene —(CH₂)₆—. R^{N} can be piperazinyl. According to another embodiment, both R³ groups are hydrogen.
n is at least 1 and has a mean value less than 2.

In an alternative embodiment, the MSA can be a polymer consisting of repeat units of either Formula II or Formula III, wherein R, R¹, R², R^{N}, and n are as defined above and x+y=1, and 0≦x≦1 and 0≦y≦1.

The polyesteramide according to this embodiment preferably has a molecular weight (Mn) of at least about 4000, and no more than about 20,000. More preferably, the molecular weight is no more than about 12,000.

It should be noted that for convenience the chemical repeat units for various embodiments are shown independently. The invention encompasses all possible distributions of the w, x, y, and z units in the copolymers, including randomly distributed w, x, y and z units, alternating distributed w, x, y and z units, as well as partially, and block or segmented copolymers, the definition of these kinds of copolymers being used in the conventional manner as known in the art. In some embodiments, the mole fraction of w to (x+y+z) units can be between about 0.1:0.9 and about 0.9:0.1. In some preferred embodiments, the copolymer can comprise at least 15 mole percent w units, at least 25 mole percent w units, or at least 50 mole percent w units.

The viscosity of a melt of the fluid of the self-assembling material is less than 500 Pa·-sec., preferably less than 250 Pa·-sec., even more preferably less than 100 Pa·-sec from above Tm (Tm is the polymer melting temperature) up to about 40 degrees ° C. above Tm. Some preferred materials exhibit fluid Newtonian viscosity over an oscillating test range frequency of 10⁻¹ to 10² radians per second at temperatures from above Tm up to about 40° C. above Tm. The material fluid melt viscosity can be non-Newtonian and less than 50 Pa·-sec, preferably less than 25 Pa·-sec, even more preferably less than 10 Pa·-sec from 40 degrees or more above the melt temperature, the melt temperature being defined at the temperature where crystalline portions of the copolymer materials melt or cannot be detected by conventional analytical techniques. In a preferred embodiment, the process further comprises a self-assembling material having at least one melting point, Tm, greater than about 25° C.

The self-assembling material preferably has a tensile modulus of at least 4 MPa, more preferably at least 15 MPa, and most preferably at least 50 MPa and preferably no higher than 500 MPa when the modulus of a compression molded sample of the bulk material is tested in tension at room temperature (e.g. about 20° C.). From material according to certain preferred embodiments, 2 millimeter (mm) thick compression molded plaques useful for tension-type testing (e.g., “Instron” tensile testing as would be know in the art) are produced. Prior to compression molding, the materials are dried at 65° C. under vacuum for about 24 hours. Plaques of 160 mm×160 mm×2 mm are obtained by compression molding isothermally at 150° C., 6 minutes at 10 bar (about 1.0 MPa) and 3 minutes at 150 bar (about 15 MPa). The samples are cooled from 150° C. to room temperature at a cooling rate of 20° C./minute. Depending upon the polymer or oligomer, these self-assembling materials preferably exhibit Newtonian viscosity in the test range frequency at temperatures above 100° C., more preferably above 120° C. and more preferably still at or above 140° C. and preferably less than 300° C., more preferably less than 250° C. and more preferably still less than 200° C. For one preferred

embodiment the relevant temperature range is between about 140° C. and 200° C. and above. Certain preferred materials exhibit mechanical properties in the solid state of conventional high molecular weight fiber polymers, for example the tensile modulus (of molded samples) can be from 4 MPa to 500 MPa and also exhibit some rheological properties of low molecular weight Newtonian liquids to facilitating faster processing rates. For the purposes of the present disclosure the term “Newtonian” has its conventional meaning; that is, approximately a constant viscosity with changing fluid shear rate. In preferred embodiments, the zero shear viscosity of the self-assembling material is in the range of from 0.1 Pa·s. to 30 Pa·s., more preferred 0.1 Pascal-seconds to 10 Pascal-seconds, at a temperature in the range of 180° C. and 220° C., e.g., 180° C. and 190° C. In still more preferred embodiments the viscosity of the fluid comprising the self-assembling material is in the range of from 1 to 50 Pascal-seconds at 150-170° C., and even more preferably, the viscosity of the fluid comprising the self-assembling material is in the range of from 0.1 to 30 Pascal-seconds between the temperature range of 180° C. and 190° C.

The MSA materials according to the invention can optionally be prepared as solutions for use in the electroblowing process to prepare useful sub-micron fiber and nonwovens: any solvents can be used, so long as the solvent can be readily a) pumpable or pressureable into a spinneret/die useful for the process and b) evaporated from the self-assembling material fluid during the process prior to the sub-micron fiber and nonwoven being collected onto the collector, preferably a substrate onto which the fiber may adhere. Preferred solvents include, but are not limited to: chloroform, methylene chloride, acetone, 1,1,2-trichloroethane, dimethylformamide (DMF), tetrahydrofuran (THF), ethanol, 2-propanol, dimethylacetamide (DMAc), N-methylpyrrolidone, acetic acid, formic acid, hexafluoro-2-propanol (HFIP), hexafluoroacetone, 1-methyl-2-pyrrolidone, low molecular weight polyethylene glycol (PEG) and the like or their mixtures, although other solvents as would be known or determinable to one of skill in the art may be used. The polymer solution should be selected and the volume of solvent used selected such that it is essentially removed (e.g. evaporated) when the blowing stream and fiber touches the collector (ground). In preferred embodiments the concentration range is preferably at least one weight percent, preferably at least 3 weight percent, preferably at least 6 weight, more preferably at least 10 weight percent; in some embodiments the solution concentration can be less than 98 weight percent, preferably less than 50 weight percent, preferably less than 30 weight percent, more preferably less than 18 weight percent even more preferably less than about 12, weight percent (as measured in chloroform), more preferably still less than 10 weight percent based on total weight of the fluid. The solution can further comprise various additives and other materials as would be known useful in the art, including but not limited to: other polymers, resins, tackifiers, fillers, oils and additives (e.g., flame retardants, antioxidants, processing aids, pigments, dyes, and the like). This requirement can mean that the molecular weight and molecular weight distribution needed to achieve the c/c*, with c*(being the overlap concentration in solution and c/c*, the reduced overlap concentration as would be known to the skilled artisan have values appropriate for this purpose) needing to be optimized. Additionally, the polymer solution can be mixed with additives including any resin compatible with an associated MSA, plasticizer, ultraviolet stabilizer, crosslinking or curing agent, reaction initiator, electrical dopant to facilitate the electrical charge, etc. Any polymer solution known to be suitable for use in a conventional electrospinning process may be used in the process of the invention so long as it effectively assists in the formation of sub-micron fibers from the MSA material fluid.

### Electroblown Fibers and Nonwovens

In some embodiments, the invention electroblowing process comprises:

a) feeding a stream of the fluid comprising the molecularly self-assembling material to a spinning nozzle within a spinneret to which a high voltage is applied;

b) discharging the fluid comprising the molecularly self-assembling material through the nozzle thereby initiating fiber formation so as to form a preliminary fiber;

c) simultaneously, passing compressed gas through a gas knife disposed in the spinning nozzle, thereby forming a blowing gas stream, the blowing gas stream entraining, forwarding and stretching the preliminary fiber so as to fabricate the fibers comprising the molecularly self-assembling material; and

d) collecting the fibers comprising the molecularly self-assembling material so as to form a fibrous web thereof on an electrically grounded collector; and simultaneously vacuuming the blowing gas stream from the electrically grounded collector into a vacuum chamber, the vacuum chamber being in fluid communication with the electrically grounded collector. In some embodiments, the vacuum chamber is in fluid communication with the spinneret and the electrically grounded collector, preferably the electrically grounded collector being disposed between the spinneret and the vacuum chamber.

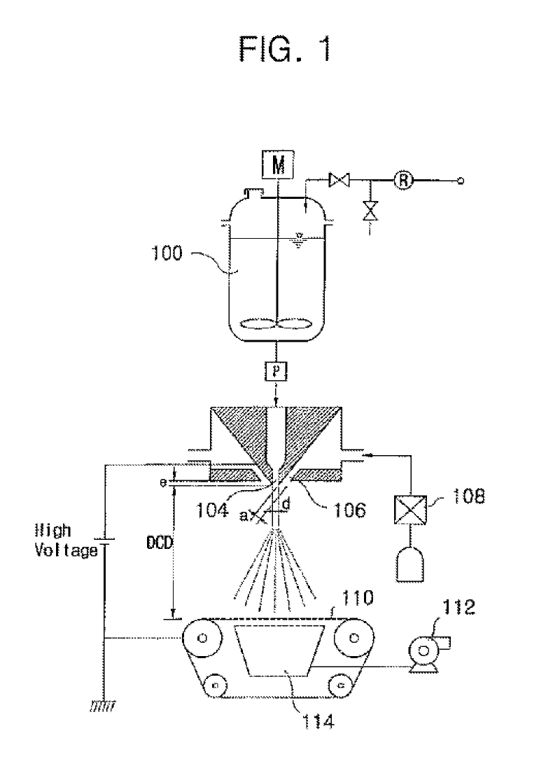

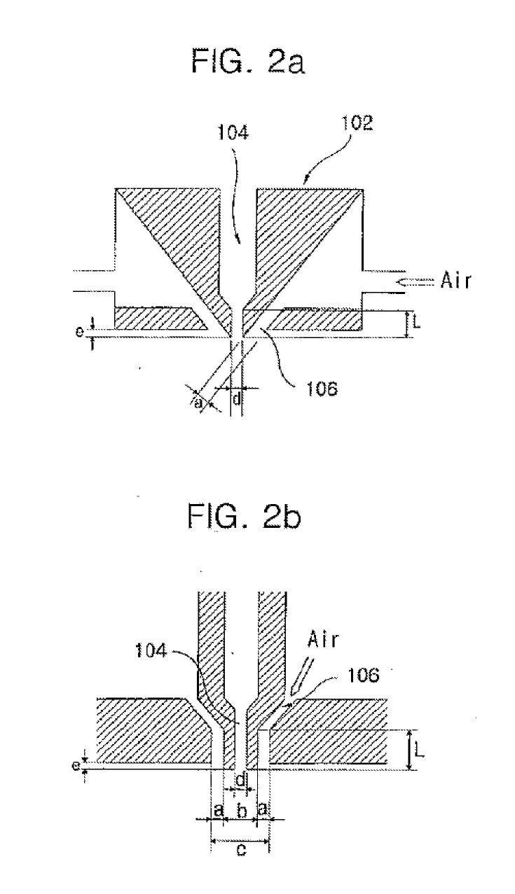

Basic electroblowing process are disclosed in PCT Patent Publication Number WO 03/080905A, incorporated herein by reference. WO 03/080905A discloses an apparatus and process for producing a (sub-micron) fiber web from a polymer solution. Referring to FIGS. 1 and 2, according to the present invention, the process comprises feeding a stream of fluid comprising a polymer and a solvent or a polymer melt from a storage tank 100 to a spinning nozzle 104 (e.g. a “die”) within a spinneret 102 to which a voltage differential is applied and through which the fluid is discharged. Meanwhile, compressed gas, optionally heated in gas heater 108, is issued from gas knives 106 disposed in the sides, the periphery, or other geometry of spinning nozzle 104. The gas is used as a blowing gas stream which envelopes and forwards the MSA-containing fluid and aids in the formation of the fibrous web by stretching the forming sub-micron fibers that are collected on a grounded/biased collector some distance from the spinneret. Preferably the collector is a porous collection belt 110 that is some distance from a vacuum chamber 114, which has vacuum applied from the inlet of gas blower 112. FIGS. 2a and 2b each illustrate the general construction of spinning nozzle 104 and the gas nozzle 106 in the spinneret 102. FIG. 2a shows the same construction as in FIG. 1 in which the gas nozzle 106 is disposed on a knife edge at both sides of the spinning nozzle 104. In the spinning nozzle 104, shown in FIG. 2a, the fluid comprising an MSA flows under pressure flows into the spinning nozzle 104 through an upper portion thereof and is injected past a capillary tube in the lower end. A number of spinning nozzles 104 similar to the above construction can be arranged in a line or matrix for a given interval while a number of gas knife 106 may also be so arranged having knife edges at both sides of the spinning nozzles 104 parallel to the arrangement thereof, sub-micron fiber can be advantageously be spun. Preferably, the gas knifes 106 each can have a gap sized so that adequate gas is available and in adequate volume to forward a fiber exiting from the spinneret as would be determinable for one skilled in the art. The lower end die/spinneret/capillary tube has a diameter d which can be sized so as to optimize the fiber diameter, typically in the range of about 0.01 millimeter to about 2.0 millimeter and preferably about 0.1 millimeter to 1.0 millimeter. The lower end capillary tube of the gas nozzle 106 has a length-to-diameter ratio L/d, which is in the range of about 1/5 to about 1/1000, preferably about 1/20 to 1/500 and more preferably 1/50 to 1/250: while not wishing to be bound by any particular theory, MSA-containing fluids exhibit extremely low viscosities at moderate temperatures and exhibit very low Newtonian viscosities allowing them to be electroblown at relatively high rates. A nozzle projection e may have a length corresponding to the difference between the lower end of a gas nozzle 106 and the lower end of a spinning nozzle 104, and functions to prevent pollution of the spinning nozzle 104.

Located a distance below the spinneret 102 is a collector for collecting the fibrous web. FIG. 1, illustrates a preferred collector comprising a moving belt or screen 110 on which the fibrous web is collected. The collector preferably includes a porous fibrous scrim, preferably comprised of a useful, typical material such as low density polyethylene and/or polypropylene, polyester or polyamide scrim as would typically be known and used in the art. The scrim can be placed onto the moving belt, whereupon the fibrous web is formed. The belt 110 is advantageously made from a porous material such as a metal or polymer screen so that a vacuum can be drawn from opposite the belt through vacuum chamber 114 from the inlet of blower 112. The collection belt is preferably grounded oppositely in charge as the spinneret so as to attract the charged MSA-containing fluid. The spin-draw ratio (the relative rate of material being forced from the spinneret compared to the rate of the fiber being pulled/drawn out) for the electroblowing (EB) process depends on many variables that can be used to change the properties, such as the diameter of the sub-micron fiber. The variables include the charge density of the fluid, viscosity, the gaseous flow rate and the electrostatic potentials (for example, a secondary electrode can also be implemented to manipulate the flow of the fluid jet stream). Some of these variables may be alterable during processing. The method further provides for the concomitant co-spinning of charged and non-charged MSA containing fluids from the same die assembly to prepare composite fibers. The temperature of the gaseous flow can be used to change the viscosity of the spinning MSA containing fluid(s). The draw forces increasing with increasing gaseous flow rate and applied electrostatic potentials. The balance between the two driving forces (electrostatic field and gaseous flow field) can be expanded further by a substantial increase in the gaseous flow rate with a practical limit of the velocity of sound, and the charge density of the fluid. For electroblowing of polymer melts or optionally, solutions, it is necessary to have the fluid fall within a certain range of viscosity, surface tension, polymer molecular weight and optionally, concentration (for solutions). These factors can preferably be determined by one of skill in the art.

The polymer discharge pressure can be in the range of about 0.01 kg/cm² to about 200 kg/cm², more advantageously in the range of about 0.1 kg/cm² to about 20 kg/cm². The polymer fluid throughput per spinneret hole or capillary (e.g. fluid flow rate) is in the range of about 0.01 grams/minute to about 50 grams/minute, preferably about 0.05 grams/min to about 25.0 grams/min, more preferably about 0.1 grams/minute to 20 grams/minute and even more preferably 0.75 grams/minute to about 10 grams/minute.

The fluid temperature is from room temperature to about 300° C. Preferably, the fluid temperature is from room temperature to about 10 degrees above the solvent boiling temperature of any solvent into which the MSA is dissolved when the fluid is a solution. When electroblowing a melt based fluid, the temperature is from the melt temperature of the MSA oligomer or polymer to 300° C., preferably, the melt fluid is between 150° C. and 250° C.

The blow or stretch gas temperature can be between 0° C. to 300° C., preferably 25° C. to 200° C., more preferably 40° C. to 150° C. For solvent-based solutions the gas temperature is preferably about room temperature to about 10 degrees above the solvent boiling temperature, and for melt-based fluids the temperature is preferably 150° C. to 230° C. The blow or stretch gas blow rate can be about 0 SCFH to 300 SCFH, preferably 10 SCFH to 250 SCFH, more preferably 30 SCFH to 150 SCFH(SCFH-cubic feet gas per hour of gas flow at standard conditions of temperature and pressure-gas dependent). The velocity of the compressed gas can be between about 10 meters/minute and about 20,000 meters/minute, and more advantageously between about 100 meters/minute and about 3,000 meters/minute. Blowing gas can be compressed air, nitrogen, inert gas such as argon and the like or mixtures of gases such as nitrogen and compressed gas to control any degradation of the MSA that might occur. The gas can be a reactive gas or partially reactive gas mixture.

The voltage differential (e.g. the electric field) between the electrode and the spinneret is in the range of about 0.1 to about 200 kilovolts, preferably in the range of 1.0 to 150 kilovolts, more preferably 10 to 60, kilovolts, and in one preferred melt electroblowing embodiment the voltage differential is 60 to 120 kilovolts, and in one preferred solution electroblowing embodiment, the voltage differential is 1 to 40 kilovolts. One of skill in the art can establish the required voltage for a given fiber. The voltage differential can have a positive or negative polarity with respect to the ground potential or a biased voltage differential, for example the voltage difference can be based on electrodes having +20 kilovolts to −20 kilovolts for a voltage differential of about 40 kilovolts. Additionally, other electro-biasing field controlling sources of voltage can be applied as would be know in the art to control or contain the electro blown fibers within the apparatus so that they can be collected at a collector.

The distance between the spinneret and the collector surface (also referred to as the “die to collector distance” or “DCD” or “electrode distance”; illustrated in FIG. 1) may be in the range of about 1 cm to about 500 cm, preferably in the range of about 5 cm to about 100 cm and more preferably in the range of about 10 cm to 50 cm.

While not wishing to be bound by theory, it is believed that the forwarding gas stream provides a majority of the forwarding forces in the initial stages of drawing of the fibers from the issued polymer stream and in the case of optional polymer solutions, simultaneously strips away the mass boundary layer along the individual fiber surface thereby greatly increasing the diffusion rate of solvent from the polymer solution in the form of gas during the formation of the fibrous web. At some position, the local electric field around the fluid stream is of sufficient strength that the electrical force becomes the dominant drawing force which ultimately draws individual fibers to diameters measured in the tenths of microns range. The present process is preferably useful for the spinning of fibers of self-assembling materials, most preferably self-assembling copolyesteramide, copolyetheramide, copolyetherester-amide, copolyester-urethane, copolyether-urethane, copolyester-urea, copolyether-urea and mixtures: electroblowing only requires that the combined electrostatic and blowing forces are strong enough to overcome the surface tension of a charged self-assembling fluid droplet thereby permitting the use of electrostatic fields and gas flow rates that can be significantly reduced compared to either traditional process alone, although variations in either to prepare a desired MSA are possible. The fluid used in the present process can be a polymer in the melt state (e.g. a fluid that can have minor portions of other additives) or optionally, a polymer and at least one solvent for the polymer to form a solution. Additionally, the melt or the solution can be a multi-component system, thus allowing for the combined electroblowing of combinations of two or more MSA or a combination or at least one MSA with a traditional polymer at the same time. MSA material containing fluids are believed especially useful in electroblowing due to the minimization of the material association behavior in the fluid (either melt or in solution) state due to the apparently rapid association of the molecules when a triggering stress is placed on the MSA since, at the die/spinneret, the MSA molecules can preferably undergo partially stress induced extension in the blowing gas stream and therefore rapid solidification and then drawn to the collector. Polymer association can significantly increase the apparent molecular size. As a result, the corresponding viscosity increases substantially. It should be noted that the term ‘gas’ denotes suitable materials in the gaseous state, including but not limited to, air, nitrogen, reactive gases and inert gases, as well as mixtures thereof. Preferred gases are air and nitrogen.

The fibers and nonwovens can be useful in garments, cloths and fabrics, gas and liquid filters and stock, papers, geotextiles, construction compositions and fabrications, coatings, synthetic animal hides, electronic components, composites, films and film precursors, absorptive wipes or medical implants and devices, hygiene (diaper coverstock, adult incontinence, training pants, underpads, feminine hygiene), industrial garments, fabric softeners, home furnishings, automotive fabrics, coatings and laminating substrates, agricultural fabrics, shoes and synthetic leather.

### EXAMPLES

### Example 1

### Representative Synthesis of a Self-Assembling Copolyesteramide

An amide diol ethylene-N,N″-dihydroxyhexanamide (“Diamide-diol”) monomer batch is prepared by reacting 1.2 kg ethylene diamine (EDA) with 4.56 kg of ε-caprolactone under a nitrogen blanket in a stainless steel reactor equipped with an agitator and a cooling water jacket. An exothermic condensation reaction between the ε-caprolactone and the EDA occurs causing the temperature to rise gradually to about 80 degrees Celsius (° C.). A white deposit forms and the reactor contents solidify, and the stirring stops. The reactor contents are cooled to 20° C. and are allowed to rest for 15 hours. The reactor contents are heated to 140° C. at which temperature the solidified reactor contents melt. The liquid product is then discharged from the reactor into a collecting tray. A proton nuclear magnetic resonance study of the resulting product shows that the molar concentration of Diamide-diol in the product exceeds 80 percent. The melting point of the Diamide-diol product is 140° C.

An MSA copolyesteramide with 50 mole % amide content is prepared by using a 100 Liter single shaft Kneader-Devolatizer reactor equipped with a distillation column and a vacuum pump system that is nitrogen purged/padded and heated to 80° C. (based on thermostat). Dimethyl adipate (DMA), 38.324 kg and Diamide-diol monomer, 31.724 kg equivalent to the previously described preparation are fed into the kneader. The slurry is stirred at 50 rpm. Butane diol (BD), 18.436 kg is added to the slurry at a temperature of about 60° C. The reactor temperature is further increased to 145° C. to obtain a homogeneous solution. Titanium (IV) butoxide catalyst, 153 g in 1.380 kg butane diol is injected into the reactor at temperature of 145° C. in the reactor and methanol evolution starts. The temperature in reactor is slowly increased to 180° C. in 1.75 hours and is held for 45 additional minutes to complete the methanol removal/distillation at ambient pressure. 12.664 kilograms of methanol is collected. The reactor temperature is increased to 130° C. and the vacuum system activated stepwise to a reactor pressure of 7 millibar in 1 hour. Temperature in the kneader/devolatizer reactor is kept at 180° C. The vacuum is increased to 0.7 mbar for 7 hours while the temperature is increased to 190° C. The reactor is kept for 3 additional hours at 191° C. and with vacuum ranging from 0.87 to 0.75 mbar. Samples are taken (sample 1); melt viscosities are 6575 milliPascal-seconds @ 180° C. and 5300 milliPascal-seconds @ 190° C. The reaction continues for another 1.5 hours until the final melt viscosities are obtained as 8400 milliPascal-seconds @ 180° C. and 6575 milliPascal-seconds @ 190° C. (sample 2). Then the liquid Kneader/Devolatizer reactor contents are discharged at high temperature of about 190° C. into collecting trays, the polymer was cooled to room temperature and grinded. Final product is 57.95 kg (87.8% yield) of melt viscosities 8625 milliPascal-seconds @ 180° C. and 6725 milliPascal-seconds @ 190° C. (sample 3). The melt viscosity of all samples is shown in Table 1.

TABLE 1
Melt viscosities and molecular weights of samples
of MSA Copolyesteramide

| | | | Viscosity @ | Viscosity @ | |
|---|---|---|---|---|---|
| Hours in | | | 180° C. | 190° C. | |
| full | | Spindle No. | [milliPascal- | [milliPascal- | Mn, 1H |
| vacuum* | Sample | 28** [rpm] | seconds] | seconds] | NMR |
| 10 | 1 | 20 | 6575 | 5300 | 6450 |
| 11.5 | 2 | 20 | 8400 | 6575 | 6900 |
| 11.5 | 3 | 20 | 8625 | 6725 | 7200 |

*Vacuum < 1.2 mbar
**Viscometer used: Brookfield DV-II+ Viscometer ™

An additional polyesteramide having approximately 50 mole percent amide content and an estimated molecular weight (Mₙ via proton NMR) of a 5,000 g/mole is prepared.

### Example 2

### Melt Electroblowing the 5000 Mₙ Self-Assembling Polymer from Example 1

An electroblowing apparatus as described in WO 03/080905A is used to produce sub-micron fiber and nonwoven web from a polymer fluid, including melt and solvent-based solution. This apparatus is illustrated in FIG. 1 described below. The apparatus includes a feeding system for feeding a stream of a polymer fluid comprising either a polymer melt or a solution from storage tank 100 to a spinning nozzle 104 (e.g. a “die”) within a spinneret 102 to which a voltage is applied and through which the polymeric fluid is discharged. A compressed gas that is optionally heated in a heater 108, is blown through a so-called gas knife, 106 that are disposed in the periphery (depending on die geometry) of spinning nozzle 104. The gas blows the gas stream which envelopes and forwards the MSA-containing fluid and aids in the formation of the fibrous web, by stretching the nascent forming fibers that are collected onto grounded (or electrically biased) collector 110 some distance from the spinneret that is a porous collection belt some distance from vacuum chamber 114 which has vacuum applied from the inlet of gas blower 112. Spinning nozzle 2b is used for preparing the fibers and nonwoven electroblown web of the self-assembling polymers in this example. The fluid comprising the self-assembling polymer having a Mₙ of 5000 grams/mole flows under pressure with heating into the spinning nozzle 104 embodied in FIG. 2b and is injected through the nozzle in the lower end. The gas knife has a gas gap sized so that adequate gas is available and in adequate volume to forward the fiber exiting from the spinneret. The nozzle lower end has a diameter of 0.1 millimeter. The lower end capillary tube of gas nozzle 106 has a length-to-diameter ratio L/d, of about 1/10. A porous fibrous scrim of polypropylene is placed on the collector to give a die to collector distance of approximately 25 centimeter. The electrical potential is set to approximately 100 kV. The gas flow rate (compressed air used as gas) is 150 SCFH. The gas temperature is set to 220° C. and the polymer melt temperature 170° C. The polymer flow rate is set to approximately 0.02 grams/minute. The process is run and a nonwoven web is collected.

### Example 3

### Solution Electroblowing of the 7200 Mₙ Self-Assembling Polymer from Example 1

The same basic apparatus used in Example 2 is used to electro-blow a 12 weight percent solution of the 7200 grams/mole Mₙ self-assembling polymer from Example 1 dissolved in chloroform. A porous fibrous scrim of polypropylene is placed on the collector to give a die to collector distance of approximately 25 centimeter. The electrical potential is set to approximately 40 kV. The gas flow rate (compressed air used as gas) is 150 SCFH. The gas temperature is set to room temperature, as is the polymer solution temperature. The solution flow rate is set to approximately 0.1 grams/minute. The gas flow rate (compressed air used as gas) is 50 SCFH. The process is run and a nonwoven web is collected.

While the invention has been described above according to its preferred embodiments of the present invention and examples of steps and elements thereof, it may be modified within the spirit and scope of this disclosure. This application is therefore intended to cover any variations, uses, or adaptations of the instant invention using the general principles disclosed herein. Further, this application is intended to cover such departures from the present disclosure as come within the known or customary practice in the art to which this invention pertains and which fall within the limits of the following claims.

1. A process for fabricating fibers, the process comprising electroblowing a fluid comprising a molecularly self-assembling material, thereby producing fibers comprising the molecularly self-assembling material.

2. The process of claim 1 wherein temperature of the fluid is from about room temperature to 300° C.

3. The process of claim 1 wherein at least about 95% of the fibers have a diameter of less than 3 microns.

4. The process of claim 1 wherein the fluid comprises a melt of the molecularly self-assembling material.

5. The process according to claim 4 wherein the molecularly self-assembling material is selected from the group consisting of polyesteramides, copolyesteramide, copolyetheramide, copolyetherester-amide, copolyester-urethane, copolyether-urethane, copolyester-urea, copolyether-urea, and mixtures thereof.

6. The process according to claim 1 wherein the molecularly self-assembling material has a number average molecular weight of from 2000 grams per mole to 70,000 grams per mole.

7. (canceled)

8. (canceled)

9. (canceled)

10. The process of claim 1 wherein the molecularly self-assembling material comprises repeat units of formula I: 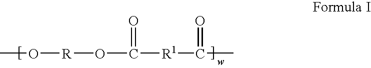
and units selected from the group consisting of
esteramide units of Formula II and III: 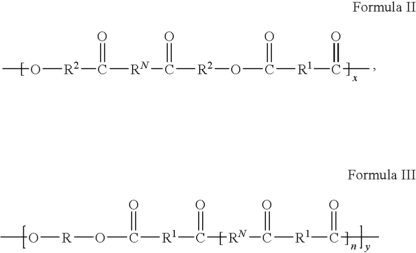
and ester-urethane units of Formula IV: 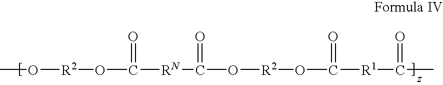
or combinations thereof wherein:
R at each occurrence is independently a C₂-C₂₀ non-aromatic hydrocarbylene group, a C₂-C₂₀ non-aromatic heterohydrocarbylene group, or a polyalkylene oxide group having a group molecular weight of from about 100 to about 5000 g/mol;
R¹ at each occurrence is independently a bond, or a C₁-C₂₀ non-aromatic hydrocarbylene group;
R² at each occurrence is independently a C₁-C₂₀ non-aromatic hydrocarbylene group;
R^{N} is —N(R³)—Ra—N(R³)—, where R³ is independently H or C₁-C₆ alkylene, Ra is a C₂-C₂₀ non-aromatic hydrocarbylene group, or R^{N} is a C₂-C₂₀ heterocycloalkyl group containing the two nitrogen atoms, wherein each nitrogen atom is bonded to a carbonyl group according to Formula III;
n is at least 1 and has a mean value less than 2;
w represents the ester mole fraction of Formula I, and x, y and z represent the amide or urethane mol fractions of Formulas II, III, and IV; where w+x+y+z=1, and 0<w<1, and at least one of x, y and z is greater than zero but less than 1.

11. The process of claim 1 wherein the molecularly self-assembling material comprises at least one homopolymer of either repeat units of Formula II or Formula III wherein: 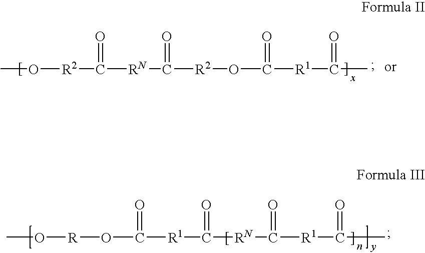
wherein R at each occurrence is independently a C₂-C₂₀ non-aromatic hydrocarbylene group, a C₂-C₂₀ non-aromatic heterohydrocarbylene group, or a polyalkylene oxide group having a group molecular weight of from about 100 to about 5000 g/mol;
R¹ at each occurrence is independently a bond, or a C₁-C₂₀ non-aromatic hydrocarbylene group;
R² at each occurrence is independently a C₁-C₂₀ non-aromatic hydrocarbylene group;
R^{N} is —N(R³)—Ra—N(R³)—, where R³ is independently H or C₁-C₆ alkylene, Ra is a C₂-C₂₀ non-aromatic hydrocarbylene group, or R^{N} is a C₂-C₂₀ heterocycloalkyl group containing the two nitrogen atoms, wherein each nitrogen atom is bonded to a carbonyl group according to Formula III; and n is at least 1 and has a mean value less than 2.

12. The process according to claim 1 wherein flow rate of the fluid is from 0.01 grams per minute to about 50 grams per minute.

13. The process of claim 1, further comprising collecting the fibers as a fiber set so as to form a fibrous web thereof.

14. (canceled)

15. The process of claim 1 wherein about 50% of the fibers are between 0.25 micron and 0.5 micron in diameter.

16. The process according to claim 1 wherein the electroblowing comprises:
a) feeding a stream of the fluid to a spinning nozzle within a spinneret to which a high voltage is applied;
b) discharging the fluid through the nozzle thereby initiating fiber formation so as to form a preliminary fiber;
c) simultaneously, passing compressed gas through a gas knife disposed in the spinning nozzle, thereby forming a blowing gas stream, the blowing gas stream entraining, forwarding and stretching the preliminary fiber so as to fabricate the fibers comprising the molecularly self-assembling material; and
d) collecting the fibers comprising the molecularly self-assembling material so as to form a fibrous web thereof on an electrically grounded collector; and simultaneously vacuuming the blowing gas stream from the electrically grounded collector into a vacuum chamber, the vacuum chamber being in fluid communication with the electrically grounded collector.

17. The process according to claim 1, wherein viscosity of the molecularly self-assembling material is less than 100 Pa·-sec. from above Tm up to about 40 degrees ° C. above Tm.

18. The process according to claim 1, the fluid comprising a melt of the molecularly self-assembling material, the melt having Newtonian viscosity over the frequency range of 10⁻¹ to 10² radians per second at a temperature from above Tm up to about 40° C. above Tm.

19. The process according to claim 1, the fluid comprising a melt of the molecularly self-assembling material, the melt having a viscosity in the range of from 1 Pascal-second to 50 Pascal-seconds at 150° C. to 170° C.

20. The process according to claim 1, the fluid comprising a melt of the molecularly self-assembling material, the melt having a viscosity in the range of from 0.1 Pascal-second to 30 Pascal-seconds between the temperature range of 180° C. and 190° C.

21. (canceled)

22. The process according to claim 1, wherein the molecularly self-assembling material is characterized by at least one melting point Tm greater than 25° C.

23. An article comprising fibers formed by the process of claim 1.

24. The article of claim 23 wherein the fibers comprise a non-woven.

25. The article of claim 23 wherein the article is a filter media.
